(19) United States
(12) Patent Application Publication
(10) Pub. No.: US 2013/0168110 A1
(43) Pub. Date: Jul. 4, 2013

(54) Apparatus For Dispensing Extinguishing Liquids Such As Water, Mixtures Of Water And Foam Or Similar

(71) Applicants: Franco Baribbi, Cellatica (IT); Massimo Affo', Gussago (IT)

(72) Inventors: Franco Baribbi, Cellatica (IT); Massimo Affo', Gussago (IT)

(73) Assignee: FIRECO S.r.l., Gussago (IT)

(21) Appl. No.: 13/541,882

(22) Filed: Jul. 5, 2012

Related U.S. Application Data
(63) Continuation of application No. PCT/IB2010/055846, filed on Dec. 15, 2010.

(30) Foreign Application Priority Data
Jan. 1, 2010 (IT) GE2010A000004
May 31, 2010 (IT) BS2010A000101

(51) Int. Cl. A62C 31/24

(52) U.S. Cl. CPC A62C 31/24
USPC 169/25

(57) ABSTRACT

Described is an apparatus for dispensing extinguishing liquids such as water, mixtures of water and foam, gas, powder or similar, comprising at least one telescopic column (1, 10, 11), fitted with a series of concentric tubular elements (101, 110, 111′), extending one out of the other and comprising a fixed lower tubular element (101′) and an upper tubular element (101″) fitted with support elements (4, 7) of a monitor (5) dispensing extinguishing liquids; such telescopic column is suitable for being positioned on any fire fighting vehicle, on boats, on carts, on the ground or in another needed position.

### BACKGROUND OF THE INVENTION

1. Field of the Invention

The present invention relates to an apparatus for dispensing extinguishing liquids such as water, mixtures of water and foam or similar.

2. Description of the Prior Art

As is known, in the fire prevention sector so-called “monitor” devices are known of, for dispensing water or a mixture of water and foam at high pressure for extinguishing fires. Such monitors can be mounted on fire prevention vehicles, for example on the roof or on the bumpers of such vehicles, on boats, on carts or directly on the ground, depending on the various needs. Such monitors may if necessary be provided with means of rotation in relation to the horizontal and/or vertical axes, so as to adjust the angle of the jet (34) of water or mixture of water and foam. One of the problems of such devices is that the dispensing height of the extinguishing liquid is fixed, thereby limiting their use and efficiency.

### SUMMARY OF THE INVENTION

The purpose of the present invention is to make an apparatus for dispensing extinguishing liquids such as water, mixtures of water and foam or similar, which may advantageously be positioned directly on the ground, on vehicles, on boats or whatever else and which has an adjustable dispensing height, so as to perform efficiently and without limitation a wide range of extinguishing operations compared to the situations which can be tackled using the prior-art monitors.

Such purpose is achieved by the present invention by means of an apparatus for dispensing extinguishing liquids such as water, mixtures of water and foam or similar, characterised in that it comprises at least one telescopic column, fitted with a series of concentric tubular elements, extending one out of the other and comprising a fixed lower tubular element and an upper tubular element fitted with support elements of a monitor dispensing extinguishing liquids; such telescopic column is suitable for being positioned on any fire fighting vehicle, on boats, on carts, on the ground or in another position depending on the various needs.

Within this patent text, the terms “dispensing monitor” and “dispensing head” will be used in a substantially interchangeable manner, such expressions referring to the component of the described apparatus suitable for generating a jet of fluid, preferably pressurised, through at least one nozzle delimited by such monitor or head.

### BRIEF DESCRIPTION OF THE DRAWINGS

Further features and advantages of the present invention will be more comprehensible from the description below, made by way of a non-limiting example and with reference to the enclosed drawings, wherein:

FIG. 1 shows a side view in elevation of an apparatus for dispensing extinguishing liquids such as water, mixtures of water and foam or similar;

FIG. 2 shows a side view in elevation and partially in cross-section of a second embodiment of the present apparatus;

FIG. 3 shows a side view in elevation and partially in cross-section of a further embodiment of the present apparatus;

FIGS. 4 and 5 respectively show a perspective view and a front view of the apparatus which the present invention relates to, according to two different embodiments;

FIGS. 6 and 7 show two enlargements in longitudinal section of the apparatus illustrated in FIG. 5, along the line VI-VI, respectively at the upper and lower extremity portions;

FIGS. 8 and 9 show a dispensing head associated with two tubular elements, according to different variations;

FIGS. 10a, 10b, 10c show three longitudinal cross-sections, respectively at a portion of upper extremity, a central portion and a portion of lower extremity, in which the tubular elements are fully extended.

### DESCRIPTION OF THE PREFERRED EMBODIMENT

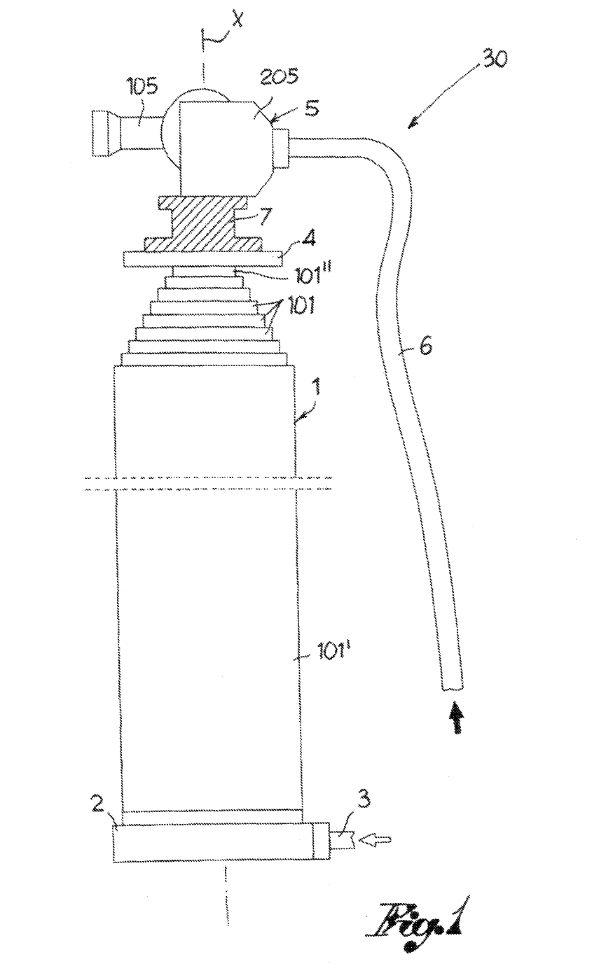

With reference to such appended drawings and with particular reference to FIG. 1, reference numeral 1 denotes a telescopic column formed of a series of concentric tubular elements 101 positioned one inside the other. The tubular element 101′ having the greatest diameter is situated at the bottom of the column 1, while the tubular element 101″ having the smallest diameter is situated at the top of the column 1 and is the innermost element of the same. The tubular element 101′ having the greatest diameter is fixed while the other tubular elements 101, 101″ can be extracted to enable the column 1 to reach any predefined height. In this first embodiment of the present apparatus the extension of the various tubular elements 101, 101″ composing the telescopic column is performed by compressed air, supplied by a duct 3 which crosses a support base 2 of the telescopic column 1. Such compressed air is supplied in an adjustable and controlled manner from a compressed air source, in itself known, for example one or more compressors, and therefore not shown. A plate 4 bearing a support element 7 of a dispensing monitor or device 5 of extinguishing liquid, such as water or a mixture of water and foam is attached to the tubular element having the smallest diameter 101″. Such monitor 5 is equipped with a dispenser lance 105 of such extinguishing liquid connected to a casing 48, 205. Upstream and to the side of said casing 48, 205 a rigid, semi rigid or flexible duct 6 supplying the extinguishing fluid is connected. The lance 105 of the monitor 5 can be attached to the casing 48, 205 by devices permitting a certain inclination upwards or downwards, such as at least one rotation pin which connects such nozzle 105 to such casing 48, 205, to such purpose the monitor 5 could be fitted with a first actuator enabling the regulation and control of the inclination at the azimuth of such lance 105 in relation to such casing 48, 205. The casing 48, 205 could further be connected to the fixed support element 7 by means of a rotation shaft enabling a certain rotation around a vertical axis. To such purpose the monitor 5 is fitted with a second regulation and control actuator of the rotation of the casing 48, 205 in relation to the support element 7 and to the telescopic column 1. Lastly, such monitor 5 may be fitted with a further actuator for regulating the aperture of the outlet nozzle 32 of the extinguishing liquid from the lance 105.

The base 2 of the telescopic column 1 of the present apparatus may be fixed t the ground, to any fire fighting vehicle, to boats, carts or whatever else, depending on the various requirements. The functioning of the present apparatus for dispensing extinguishing liquid according to this first embodiment is as follows: the telescopic column 1 is raised to the desired height by supplying compressed air from below through the duct 3, the monitor 5 can then be positioned at any height for dispensing the extinguishing liquid supplied by the duct 6 to which the extinguishing liquid is supplied by suitable pump means which withdraw such liquid from a suitable source, not shown, such as for example a tank, the normal water mains or whatever else, as needed and depending on the location in which the present apparatus is positioned. The lowering of the telescopic column 1 and consequent return of the various tubular elements composing it inside each other occurs simply by gravity, gradually reducing the air pressure.

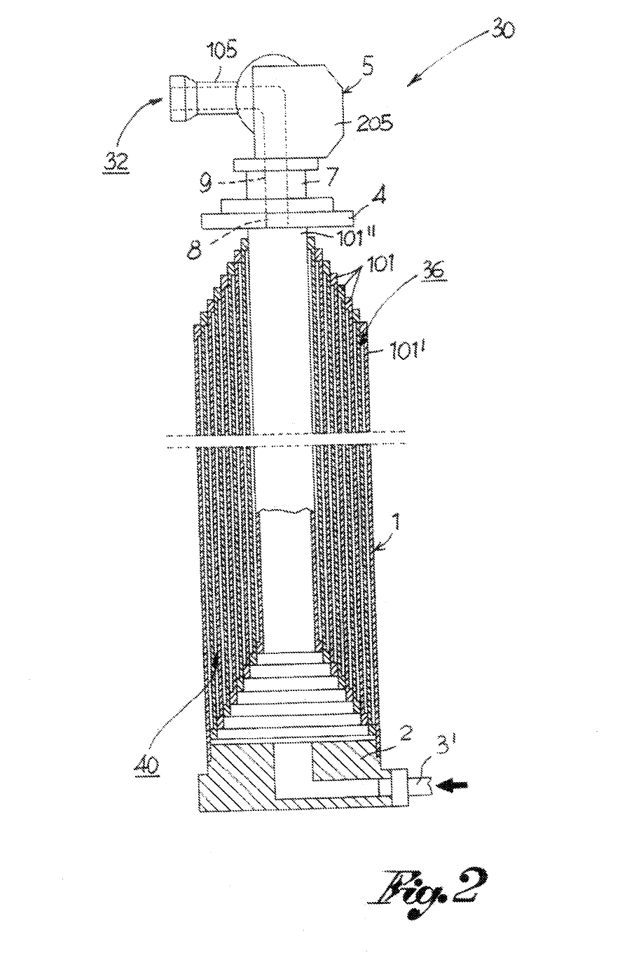

In the second embodiment of this apparatus, see FIG. 2 of the appended drawings, the pressurised extinguishing liquid is supplied directly from the bottom and from inside the telescopic column 1. The supply duct 3′ of such liquid crosses the base 2 of the column 1, at least two aligned, communicating holes are made on the plate 4 attached to the last tubular element 101″ and on the support element 7 of the monitor 5, respectively the through holes 8 and 9, which allow the pressurised liquid to reach the monitor 5 and thereby the relative dispenser lance 105. In this case the tubular elements 101, 101″ of the telescopic column 1 are extended by the pressure of the extinguishing liquid which puts pressure on the inner surface of the plate 4 to which the tubular element 101″ of least diameter of the column is connected.

FIG. 3 shows a third embodiment of the present apparatus. In this case the apparatus comprises two concentric telescopic columns 10 and 11 each formed of a series of concentric tubular elements 110 and 111, similarly to the column 1 illustrated in the embodiments described above. The telescopic column 10 is positioned inside and coaxially to the telescopic column 11 and comprises a lower tubular element 110′ having a greater diameter which is attached to a base 2, common to the two telescopic columns 10 and 11, and an upper tubular element 110″ having a lesser diameter at the top of which the plate 4 is attached. The outer telescopic column 11 also comprise a lower telescopic element 111′ having a greater diameter attached to the base 2 and an upper telescopic element 111″ having a smaller diameter at the top of which the plate 4 is attached. Substantially therefore, the inner telescopic column 10 is housed inside the tubular element 111″ having the smallest diameter of the outer telescopic column 11. The extinguishing liquid is conveyed inside the inner telescopic column 10 through the duct 3′ which crosses the base 2 and such liquid, as seen in FIG. 2, crosses the ducts 8 and 9 located on the plate 4 on the support element and reaches the lance 105 of the monitor 5 for final dispensing. Between the tubular element 110′ having the greatest diameter of the inner telescopic column 10 and the tubular element 111″ having the smallest diameter of the outer telescopic column 11 is a cylindrical annular chamber 12 which enables the compressed air, supplied from below by the duct 3 crossing the base 2, to reach the lower surface of the plate 4. The outer telescopic column 11 is raised to a desired height by means of such supply of compressed air and given that the last tubular element 110″ having the smallest diameter of the inner telescopic column supplying the extinguishing liquid is also connected to such plate 4, such inner telescopic column 10 is raised to same height by the raising of such outer telescopic column 11. Substantially therefore, such outer telescopic column 11 activated by the supply of compressed air is suitable for pushing and guiding the inner telescopic column 10 supplying the extinguishing liquid. Such outer telescopic column 11 must therefore be structurally more resistant than the inner telescopic column 10, moreover hydraulic sealing devices will be foreseen for the inner telescopic column 10 and pneumatic sealing devices for the chamber 12 defined between the outer telescopic column 11 and the inner telescopic column 10.

In the embodiments of this apparatus in FIGS. 1 and 3, providing for a column 1 or 10 raised by compressed air, it is possible, alternatively, to provide an extinguishing fluid supply hose to the monitor which passes inside the column. Such hose, similar to the duct 6 illustrated in FIG. 1, remains retracted on the bottom of the telescopic column when the column is lowered, and extends when the telescopic column is raised.

Alternatively to what has been illustrated in the embodiments of the presently described apparatus, the telescopic support column of the monitor could be raised by an electric or manual winch system, with relative pulleys, both in the case of a single telescopic column as in figures and 1 and 2 and in the case of a double telescopic column, as in FIG. 3. In both cases such winch system is positioned externally to the telescopic column. The telescopic column could also be raised by hydraulic or pneumatic actuator devices or with mechanical nut systems positioned externally and/or internally to the telescopic column. The mobile element of such winch systems, with hydraulic or mechanical nut actuators is, naturally, connected to the upper tubular element of the telescopic column, i.e. the one supporting the dispensing monitor of such extinguishing liquid.

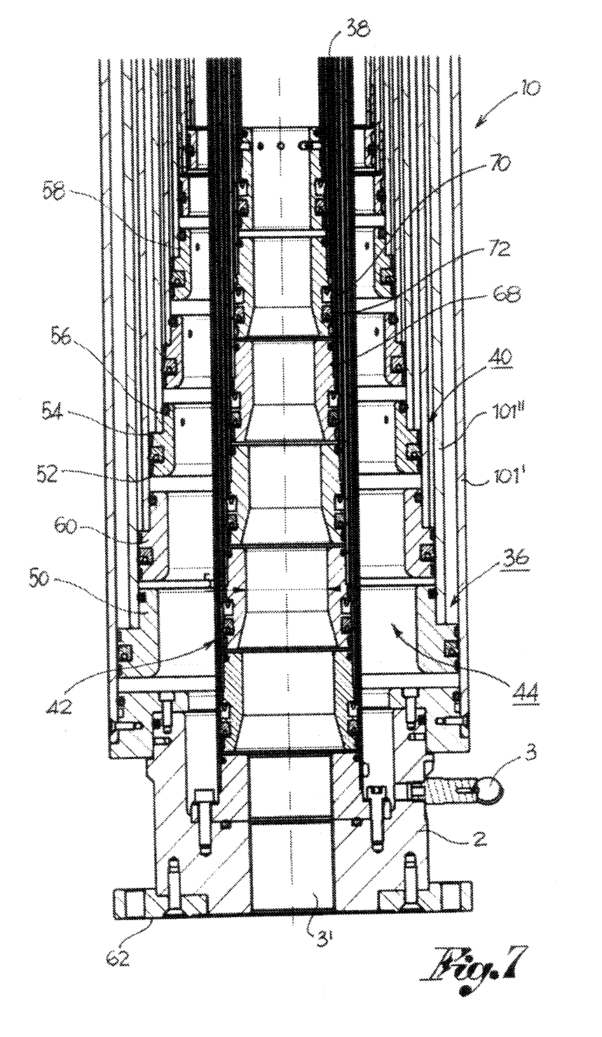

As a result, the apparatus for dispensing fluids according to the essential aspects of the present invention, comprises a fluid dispenser head 5, which identifies at least one nozzle 32 for the emission of a jet of fluid 34, schematically illustrated in FIG. 8.

According to one advantageous variation, the dispensing apparatus 30 comprises shut-off means in fluidic communication with the nozzle 32 to allow/prevent the emission of such jet of fluid 34, and/or to regulate the intensity or the flow-rate of the latter 34.

According to such variation, the shut-off means, preferably remotely operable e.g. by means of a solenoid valve, are suitable for positively or negatively influencing dispensing of the jet of fluid 34, and/or for regulating the type of jet 34 most suitable for the various conditions.

According to one embodiment variation, the shut-off means are positioned at the dispenser head 5.

Alternatively, the shut-off means are positioned upstream of the dispenser head 5 in the passage direction of the fluid being dispensed.

Preferably, the extinguishing fluids used are both liquids according to the type listed above or powders, extinguishing gases such as CO₂, or their mixtures.

According to a preferred variation, the fluid dispensing apparatus 30 further comprises detector means 46, preferably for a visual detection, associated with the dispenser head 5.

According to an embodiment variations, the detector means 46 comprise a video-camera, a camera, preferably of the type suitable for acquiring thermal, infrared, nocturnal images or the like.

In the variation shown in FIGS. 8 and 9, the detector means 46 are firmly assembled at the pointing direction of the jet of fluid 34.

In other words, according to one of such variations, the video camera is joined to the dispenser lance 105 or the casing 48, 205 in such a way that its lens is directed in the same direction as the nozzle 32, therefore in the direction of the jet of fluid 34.

According to a further variation (not shown), the detector means are mounted in a movable manner to the dispenser lance 105 or casing 48, 205 of the dispenser head 5, in such a way that such devices 46 can be controlled independently to the dispensing direction of the jet of fluid 34.

Preferably, the direction of the jet of fluid 34 and/or detector means 46 can be remotely controlled, advantageously through management and control means which communicate with suitable motor means co-operating with the nozzle 32 and/or with the means 46 for moving them.

Within this patent text the term “remote” is taken to mean any communication system enabling activation of the apparatus from another place, even distant, from that of use.

Merely by way of example, such systems comprise wireless systems, which therefore communicate via electromagnetic waves or similar, electric cables, optic fibres, ducts, which thereby entail a physical connection between the management and control means and the aforesaid motor devices.

Preferably, for the variations envisaging solutions other than wireless systems, said electric cables, optic fibres and/or ducts are at least partially positioned inside a telescopic moving column, which will be described below.

According to a further variation, the apparatus 30 further comprises lighting devices, associated with the dispenser head 5, in such a way as to generate a beam of light which can be directed, for example, at the site pointed at by the jet of fluid.

Preferably, the lighting devices comprise at least one spotlight, a plurality of LEDs, a bulb or similar.

As said above, in one embodiment, the dispensing apparatus 30 comprises at least one telescopic moving column 1, 10, 11 of the dispenser head 5.

As a result, the dispenser head 5 can be moved by operating the telescopic moving column 1, 10, 11.

Such telescopic moving column 1, 10, 11, comprises at least a first tubular element 101′, 110′, 111′, which extends around a longitudinal axis X and which defines a main containment chamber 36, and at least one second tubular element 101″, 110″, 111″ at least partially housed in the containment chamber 36 so as to be movable along the longitudinal axis X.

Consequently, the second tubular element 101″, 110″, 111″ is at least partially contained in the chamber 36 defined by the first tubular element 101′, 110′, 111′ in such a way that such tubular elements are translatable along the extension axis X of the first tubular element 101′, 110′, 111′.

Such extension axis X or longitudinal axis X corresponds substantially to the working axis of the telescopic moving column 1, 10, 11.

In other words, the telescopic moving column 1, 10, 11 is convertible from a compact configuration to a working configuration, wherein the second tubular elements 101″, 110″ and 111″ are at least partially extracted or extended from the main containment chamber 36.

Consequently, when the telescopic moving column 1, 10, 11 is positioned in the compact configuration, the second tubular elements 101″, 110″, 111″ are substantially contained in the main containment chamber 36, so as to remain substantially hidden from view and in such a way that the telescopic column 1, 10, 11 has a limited axial dimension.

However, when the telescopic moving column 1, 10, 11 is moved from a compact configuration to a working configuration, its axial dimension increases significantly in that each second tubular element 101″, 110″, 111″ projects mainly outside the main containment chamber 36, because such tubular elements are reciprocally extended in a telescopic manner.

In fact, preferably, the telescopic moving column 1, 10, 11 comprises a plurality of second tubular elements 101″, 110″, 111″, each having a progressively smaller diameter, so as to be reciprocally positioned in a telescopic manner.

According to a construction variation, the dispensing apparatus 30 comprises anti-rotation devices to prevent the reciprocal rotation of the tubular elements around an axis substantially coinciding with the longitudinal axis X.

Consequently, the anti-rotation devices co-operate with the tubular elements so that they remain integral in rotation, in at least one of the compact or working configurations, preferably both.

Preferably, the anti-rotation devices comprise at least one support element or key which extends between adjacent tubular elements in the annular chamber defined between them, that is from the outer surface of the radially innermost tubular element to the inner surface of the radially outermost tubular element.

According to one advantageous variation, such support element is suitable for breaking when the apparatus undergoes mechanical stress above a predefined threshold.

In other words, in normal conditions the support element is intact and suitable for preventing rotation between the tubular elements. However, when the apparatus undergoes mechanical stress above the predefined threshold the support element breaks or is lacerated in a controlled manner to absorb the impact, thereby preventing the apparatus from being damaged.

According to a further variation, the support element is at least partially composed of a plastic material.

According to a particularly advantageous embodiment, the jet of fluid 34 is rotatable around an axis parallel to the longitudinal axis X and/or suitable for being inclined in relation to said axis X.

Consequently, the nozzle 32 is suitable for being oriented, preferably at 360°, around a rotation axis parallel to the longitudinal axis X and/or for being inclined in relation to the same axis, optionally in projection.

According to different embodiment variations, the rotation of the jet of fluid 34 is performed by manual means or rotation motors operatively connected to the dispenser head 5, or telescopic moving column 1, 10, 11.

Consequently, according to a first variation, the dispenser head 5 is connected to the telescopic moving column 1, 10, 11 by the rotation means to perform a reciprocal rotation.

Alternatively, the dispenser head 5 is integral in rotation to the telescopic moving column 1, 10, 11, and it is this latter which is moved by the rotation devices, that are manual or motorized.

For example, the manual rotation devices comprise a rotatable support base, preferably supported on rollers or bearings, while the motorized rotation device comprises a motorized worm which acts tangentially on a gear joined in rotation to the head 5 or to the column 1, 10, 11.

Preferably, the movement between the tubular elements 101′, 110′, 111′, 101″, 110″, 111″ occurs in such a manner as to guarantee a fluidic seal between them.

In such regard, the dispensing apparatus 30 comprises fluidic sealing means interposed between the first and the second tubular element and, for the variations having a plurality of second tubular elements, inserted between each pair thereof.

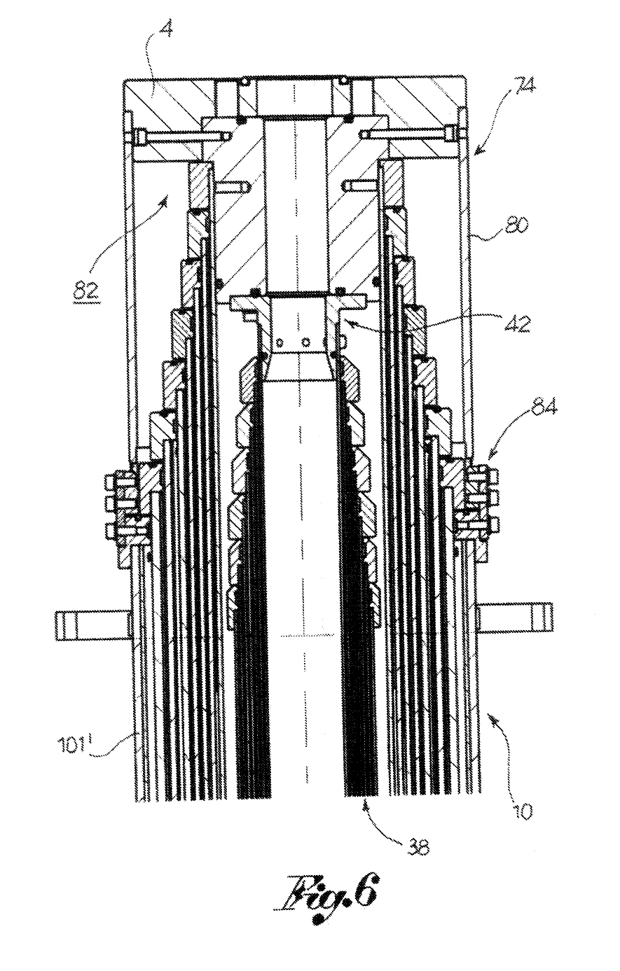

In the variation illustrated in FIG. 7, the sealing means comprise an outer sealing flange 50 joined to each tubular element at a portion of lower extremity of the latter, which defines at least one housing seat 52, 54, 56 for a gasket, O-ring, Teflon ring or the like.

Preferably, each sealing flange 50 comprises a tubular portion 58 engaging in the compartment 36 delimited by the second tubular element 101″, 110″, 111″, and an annular portion 60 connected to the tubular portion 58 and which extends radially externally to it.

Advantageously, such annular portion 60, as well as defining the aforementioned housing seat 52, 54 for the gaskets, makes it possible to maintain a certain radial distance between the reciprocally moving tubular elements, preventing their reciprocal contact by virtue of the annular chamber which they form between them, and acting as a translational guide between them.

As a result, the sealing flange 50 acts both as a sealing element, and as a guide during the translation of the telescopic column.

The dispenser head 5 is joined to the telescopic moving column 1, 10, 11 in such a way as to be translatable along the longitudinal axis X.

Consequently, the telescopic moving column 1, 10, 11 is suitable for moving the dispenser head 5 at various axial distances.

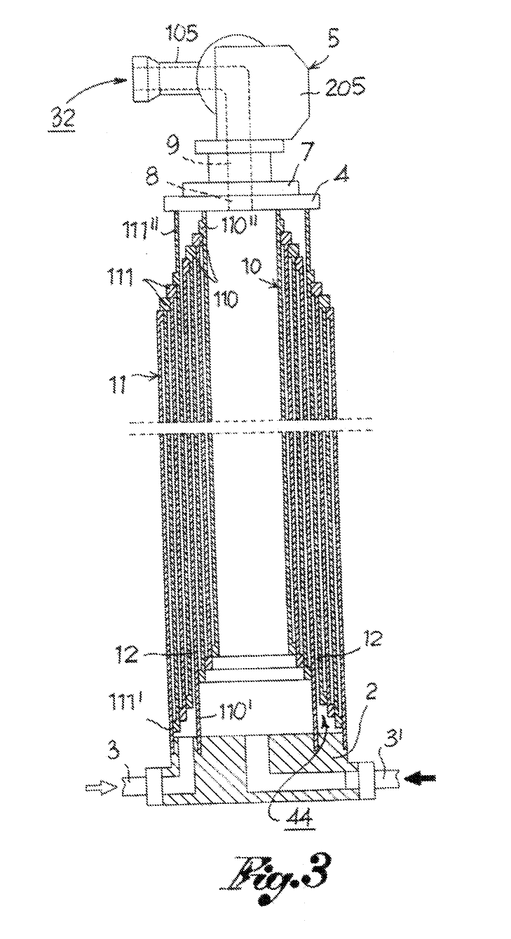

So, when the telescopic moving column 1, 10, 11, is in the compact configuration (for example as shown in FIG. 4), the dispenser head 5 is axially closer to a support surface 62 of the apparatus 30.

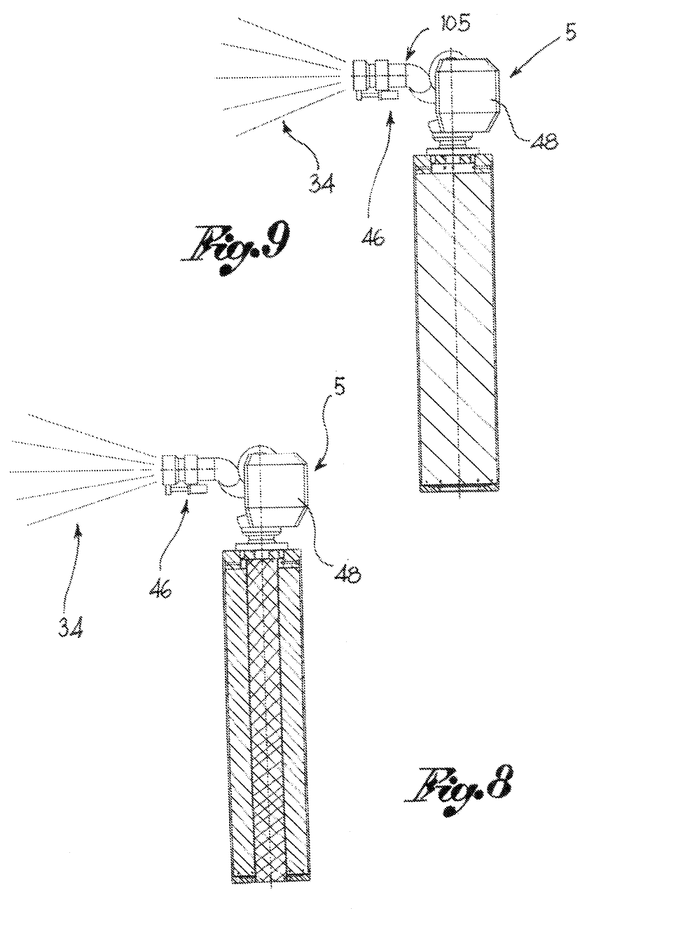

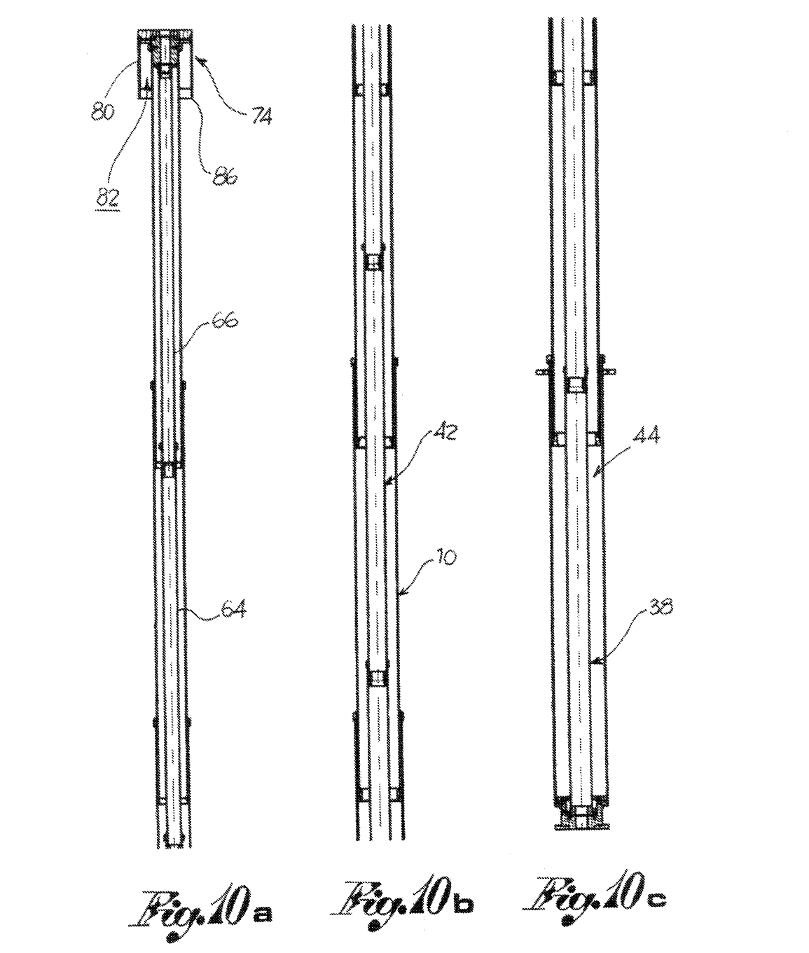

When, rather, the telescopic moving column 1, 10, 11, is in the working configuration (for example as shown in the three FIGS. 10a to 10c), the dispenser head 5 is moved at significantly greater axial distances.

For example, considering a variant in which the longitudinal axis X is positioned vertically, the dispenser head 5 is suitable for reaching considerable heights compared to the support surface 62.

The dispensing apparatus 30 comprises fluid supply means to the nozzle 32, comprising at least one fluid supply circuit which extends at least partially inside said tubular elements 101′, 110′, 111′, 101″, 110″, 111″.

As a result, innovatively, the fluid supply circuit is at least partially positioned inside the telescopic moving column so as to be protected from external agents, so as not to obstruct its operation, to enable a reduction of the complexity and dimensions of the apparatus itself.

Preferably, the supply means comprise at least one supply duct 38 which extends at least partially inside the telescopic column 1, 10, 11.

According to different embodiments, the supply duct 38 comprises a flexible hose or a rigid or expanding pipe, for example corrugated, housed in the telescopic column 1, 10, 11.

Even more preferably, at least one portion of the supply circuit comprises the compartments 36, 40 defined by the first 101′, 110′, 111′ and by the second 101″, 110″, 111″ tubular element.

As a result, according to this variation, the apparatus 30 proves extremely simplified, in that the supply circuit is at least partially composed of the compartments 36, 40 circumscribed by the tubular elements.

According to one variation, the nozzle 32 is in fluidic connection with the main containment chamber 36 through valve means suitable for allowing/preventing the emission of the jet of fluid 34 from the nozzle 32.

In other words, the translation of the tubular elements 101′, 110′, 111′, 101″, 110″, 111″ according to this variation occurs by means of the same fluid which is dispensed from the nozzle 32.

Consequently, until the dispenser head 5 reaches the desired position or height, the valve means of the apparatus 30 are suitable for limiting or for preventing the emission of the fluid from the nozzle 32; in such circumstance, inside the telescopic moving column sufficient pressure is generated to cause the translation of the tubular elements and thereby moving of the head 5.

In the variation in which the valve means limit, without completely preventing, the exit of the fluid from the nozzle 32, the quantity of incoming fluid, preferably through the duct 3 which crosses the base 2 supporting the telescopic column, must be greater than the quantity of outgoing fluid, so that the internal pressure of the telescopic column can increase.

According to this variation, simultaneously with the conversion of the telescopic column from the compact configuration to the working configuration, the dispenser head 5 will therefore dispense a jet of fluid 34 of variable intensity.

According to a preferred variation, the translation between the tubular elements 101′, 110′, 111′, 101″, 110″, 111″ occurs by means of a movement fluid different from that dispensed from the nozzle 32.

Consequently, such variation provides that the fluid dispensed from the nozzle 32 is different from that producing the movement of the telescopic column.

This way, the translation of the tubular elements and the flow/intensity of the jet of fluid can be controlled independently; for example, it is possible to regulate a certain speed of movement of the column without dispensing jets of fluid, or cause the movement of the dispenser head 5 in a series of jolts, in any case maintaining a constant dispensing flow.

According to a particularly advantageous embodiment the apparatus 30 therefore comprises a pneumatic or hydraulic movement circuit, inside which the movement fluid flows to enable the translation of the tubular elements 101′, 110′, 111′, 101″, 110″, 111″.

Preferably, the supply circuit and the movement circuit are reciprocally isolated and are suitable for being activated independently.

In other words, the fluid to be dispensed through the nozzle flows inside the supply circuit, while the movement fluid, different from the previous fluid, flows through the movement circuit, to activate the telescopic moving column 1, 10, 11; the supply of fluids to the respective circuits occurs independently, for example through a first 3 and a second 3′ supply duct by means of two different supply pumps. Advantageously, the two fluids described are reciprocally isolated, in other words, their reciprocal contact is prevented.

Preferably, the apparatus 30 further comprises a telescopic supply column 10, 42 at least partially housed in the telescopic moving column 1, 10, 11.

As a result, the apparatus 30 according to this variation, is composed of a pair of telescopic columns, preferably positioned coaxially, so as to supply the fluid to the nozzle, move the dispenser head and mechanically strengthen the apparatus.

In relation to the characteristics of the telescopic supply column 10, 42, reference is made mutatis mutandis to what was said above for the telescopic moving column 1, 10, 11. In particular, the telescopic supply column 10, 42 also comprises reciprocally translatable internal tubular elements 64, 66 in such a way as to guarantee a fluidic seal between them.

According to this variation, the dispensing apparatus 30 comprises fluidic sealing devices interposed between the inner tubular elements 64, 66 of the telescopic supply column 10, 42.

Preferably, such fluidic sealing devices of the telescopic supply column 10, 42 are shaped in such a way as to guarantee a fluidic seal in both axial directions of the telescopic supply column 10, 42.

According to the variation shown, the fluidic sealing devices of the telescopic supply column 10, 42 comprise an inner sealing flange 68 joined to each tubular element 64, 66 at a portion of lower extremity of the latter, which defines at least one pair of housing seats 70, 72 for a gasket, O-ring, Teflon ring or the like.

Similarly to the outer sealing flange 50 of the telescopic moving column, the inner sealing flange 68 preferably comprises a tubular portion and an annular portion, the latter being connected to the tubular portion and extending radially externally to the former.

Preferably, the element or pair of sealing elements engaged in the seats of the aforementioned flanges 50, 68 are lip packing seals and, in the variation foreseeing a pair of such gaskets, these are positioned reciprocally in an inverted manner.

In the variation with two telescopic columns, between the telescopic supply column 10, 42 and the telescopic moving column 1, 10, 11 a fluid chamber 44 is advantageously defined, preferably annular, inside which the movement fluid flows.

As a result, as already mentioned above, the movement fluid remains substantially confined inside the fluid chamber 44.

Furthermore, the presence of two telescopic columns gives the apparatus which the invention relates to increased mechanical resistance.

According to one advantageous embodiment the dispensing apparatus 30 comprises means of stopping the telescopic moving column 1, 10, 11 suitable for limiting the stroke of said column 1, 10, 11 along the longitudinal axis X.

In fact, where the pressure of the fluid supplied to the nozzle 32 exceeds a predefined value, so that the nozzle acts so as to narrow the through section, the moving column tends to automatically convert to the working configuration, distancing the dispenser head 5 further from the support base 2, even when such further axial shifting of the head 5 is neither desired nor opportune.

According to one embodiment variation, the stopping devices comprise at least one tie-rod, operatively connected to the dispenser head 5, for example an extremity of which is attached at the plate 4 associated to the last tubular element 101″; according to such variation, the tie-rod is progressively turned at the opposite end, for example by means of a winch, as far as the desired working position.

According to a further embodiment variation, the stopping devices are of the gravimetric type, in other words the dispenser head 5 is provided with seats suitable for receiving appropriate weights to axially limit the stroke of the telescopic moving column.

According to a further embodiment variation, the stopping devices are of the electric/electronic type, that is, suitable management and control means act on the fluid supply pumps, preferably following signals received by sensor devices, and/or by the valve means of the system, for example to increase/decrease the supply flows of at least one of the fluids of the system, accelerate/decelerate/interrupt dispensing of the jet of fluid from the nozzle, and/or exercise a suitable counter-pressure on at least one of the fluids described.

According to a further preferred variation, the dispensing apparatus 30 comprises axial blocking means of the telescopic moving column 1, 10, 11 suitable for making the tubular elements 101′, 110′, 111′, 101″, 110″, 111″ integral in translation.

Essentially, the axial blocking means of the telescopic moving column perform a function similar to the stopping devices, and are provided alternatively or additionally to the latter.

According to a preferred embodiment variation, the axial blocking means comprise at least one attachment element for each pair of tubular elements 101′, 110′, 111′, 101″, 110″, 111″, which acts radially between such elements to make them axially integral.

Merely by way of example, such blocking element, preferably releasable, comprises threaded screws or rods, bolts, clips, flanges, keys or the like.

The axial height of each tubular element being known, the actuation of the axial blocking means entails a preliminary evaluation of the desired axial dimensions of the telescopic column in the working configuration. Subsequently, if the telescopic column is composed of a number of tubular elements greater than the desired axial dimension, so that converting them all to the working configuration an axial dimension greater than that desired would be achieved, the pairs of tubular elements are joined by means of the blocking means as required.

Preferably, the dispensing apparatus 30 further comprises means of inclining the telescopic moving column 1, 10, 11 to direct the longitudinal axis X in relation to a reference surface, preferably a support surface.

In other words, the inclination devices, preferably a rotatable support base or a cylinder-piston group co-operating with the telescopic moving column, permit the inclination of the working axis of such column 1, 10, 11, for example to position large sized apparatus 30 in a more suitable position for transport, for example, lying down, or to reach difficult to access points with the jet of fluid.

According to a particularly preferred variation, the dispensing apparatus 30 comprises management and control means operatively connected to the motor devices for the orientation of the jet of fluid 34, to the detector means 46, to the lighting devices, to the supply pumps of the fluids of the system, to the shut-off means, to the valve means, and/or to the sensor devices used in conjunction with the previous types of devices.

Advantageously, the management and control means comprise at least one user station and console, preferably portable, which can be operated by a user, for example by means of a suitable interface.

According to a preferred variation, the dispensing apparatus 30 further comprises a protective element 74, suitable for at least partially overlapping the portion 76, 78 of the second tubular element 101″, 110″, 111″, preferably the plurality of portions 76, 78 of the second tubular elements 101″, 110″, 111″, emerging from the main containment chamber 36, when the telescopic moving column 1, 10, 11 is positioned in the compact configuration.

In fact, when the telescopic moving column 1, 10, 11 is in the compact configuration, the first and second tubular elements have a staggered truncated cone appearance as illustrated in FIG. 4.

Consequently, the protective element 74 is suitable for concealing the portion 76, 78 of the second tubular element 101″, 110″ in such a manner as to at least partially conceal it from view and to protect it.

In the variation shown, the protective element 74 has a tubular wall 80, which extends around the longitudinal axis X and which defines an element compartment 82 for receiving the aforesaid portion 76, 78 of the second tubular element 101″, 110″.

Preferably, the protective element 74 is connected to and extends from the plate 4, bearing the dispenser head 5.

According to a particularly advantageous variation, the apparatus 30 comprises rotational blocking means of the protective element 74, suitable for preventing its rotation around the longitudinal axis X.

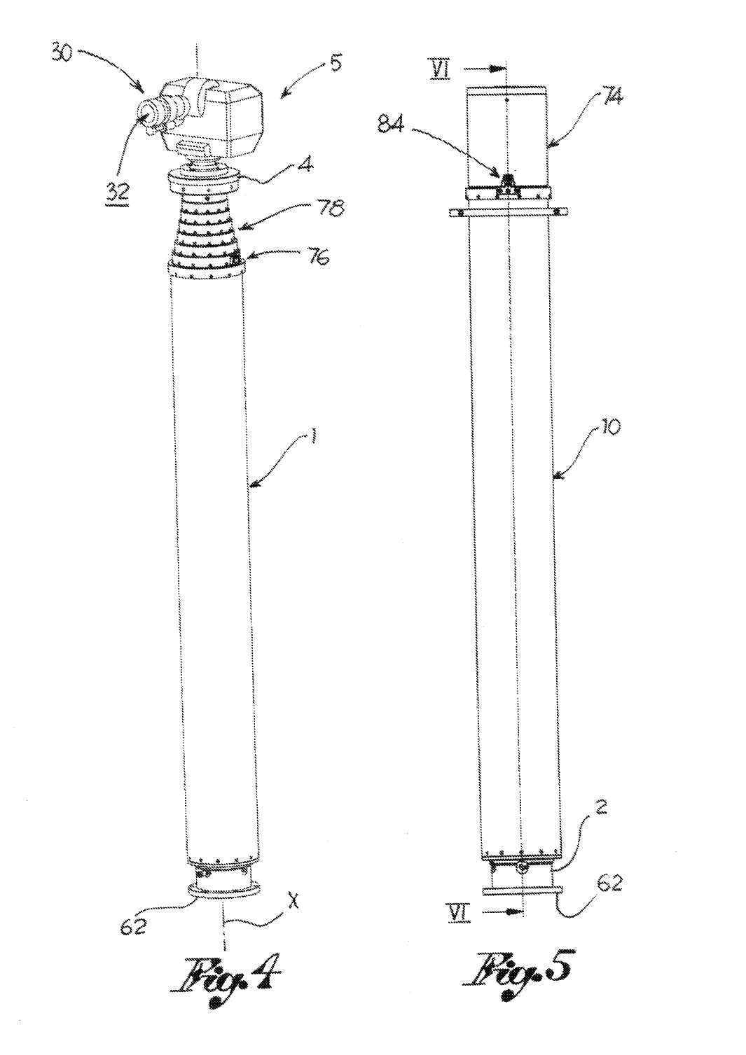

In the variation illustrated in FIGS. 5 and 6, the blocking means have a stop element 84 joined to the first tubular element 101′, 110′, 111′, suitable for working on at least one portion of the protective element 74.

Preferably, the stop element 84 is suitable for engaging, preferably by a shaped coupling, with a lower rim 86 of the protective element 74.

Even more preferably, the stop element 84 has a substantially wedge-shaped profile so that when the telescopic moving column 1, 10, 11 is converted towards the compact configuration, such profile exerts a retaining force on the protective element 74.

The present invention relates lastly to a fire fighting vehicle, such as a fire engine or fire cart, mounting an apparatus 30 for dispensing extinguishing fluids according to any of the variations illustrated above.

Innovatively, the apparatus which the present invention relates to permits, following its positioning and installation in a place of use, performance of a wide variety of diverse configurations of emission of the jet of fluid.

Advantageously, the apparatus which the present invention relates to permits use even in places where the use of water or other similar liquids is not recommended with moderate electric conduction properties, for example on electric or electronic control switchboards or panels.

Advantageously, the apparatus which the present invention relates to permits use even in conditions of poor, insufficient visibility or where visibility is jeopardized by the conditions of use, for example in the presence of smoke or flames.

In fact, the selection of appropriate detector means enables dispensing of the jet of fluid with extreme accuracy even in the toughest conditions.

Advantageously, the apparatus which the present invention relates is suitable for dispensing the jet of fluid in a direction the same as or different from the direction in which the nozzle is pointed.

This makes it possible to control a specific situation, such as a fire, in a drastically more efficient manner.

In fact, during dispensing of the jet of fluid in a first site, the detector means which the present invention relates to enable monitoring of other sites of potential danger.

Advantageously, the apparatus which the present invention relates to can be remotely controlled, in such a way that its use is always in conditions of safety for the operator, even when the apparatus itself has to combat situations of danger.

Advantageously, the extension/translation of the tubular elements occurs in such a way as to combine a significant reduction of friction with a good fluidic seal.

This way, the useful working life of the apparatus which the present invention relates is considerably longer than the telescopic columns of the prior art.

Advantageously, the apparatus which the present invention relates is suitable for directing the jet of fluid in various directions, for example downwards or upwards and furthermore to regulate the type of jet most suited to the various requirements.

For example, in some situations it might be desirable to direct a fierce jet of fluid, or a nebulized jet which in other circumstances might be deleterious or ineffective.

Advantageously, the apparatus which the present invention relates to makes it possible to independently control the movement of the telescopic column and the method of dispensing, so as to cater to the various requirements.

Advantageously, the apparatus which the present invention relates is suitable for preventing the mixing of the various process fluids circulating within it.

In fact, if for example an oil from the hydraulic moving circuit were to mix with the extinguishing fluid this would negatively affect the extinguishing capacity of the apparatus, in that such oil would catch fire upon contact with a flame.

Advantageously, the apparatus which the present invention relates to has been designed to support mechanical stress of various kinds and, in particular, is highly resistant to fatigue.

The dispensing of the jet of fluid at the head of the telescopic column in fact generates repeated mechanical stress which is transmitted all along the column; the present apparatus has however been designed in such a way as to be suitable for absorbing a wide variety of stresses, in a wide range of frequencies and intensity.

Advantageously, the apparatus which the present invention relates to is of extremely reduced dimensions in the compact configuration, but nonetheless permits the dispenser head to reach heights or distances unthinkable with the devices of the prior art.

Advantageously, the apparatus which the present invention relates to requires little or no servicing given its reliability and simple construction.

Advantageously, the apparatus which the present invention relates to is extremely solid in that it is suitable for withstanding both the stress deriving from its use, and from any transport.

A person skilled in the art may make variations or replacements of elements with others functionally equivalent to the aforementioned apparatus and vehicle so as to satisfy specific requirements.

For example, despite the movement between the tubular elements having been illustrated above using hydraulic or pneumatic systems, it may be performed using alternative systems, for example mechanically by means of nut systems, without any inventive effort.

Furthermore, the apparatus has been described above mainly in relation to fire-fighting applications. Nonetheless, such apparatus may also be rendered suitable for agricultural use, for example for watering fields or distributing fertilizers, weed killers or pesticides, for amusement purposes, for example in stadiums, amusement parks or the like, or for military or anti-riot use, for example to quell episodes of urban warfare or rebellions/riots in prisons.

Lastly, in the above description the dispenser head has always been described as dispensing a jet of fluid. However, it is possible to hypothesis that the supply means of the head be commuted so as to aspirate fluid rather than dispense it.

As a result, the apparatus which the present invention relates to is suitable for being used in conjunction with a draining pump, for example to drain water from basements in the case of floods or for similar applications.

Such variations too are contained within the scope of protection as defined by the appended claims.

Moreover, each variation described as belonging to a possible embodiment may be made independently of the other variations described.

1. Apparatus for dispensing fluids, preferably extinguishing fluids, comprising:
a dispenser head of the fluid, which identifies at least one nozzle for the emission of a jet of fluid;
at least one telescopic moving column of the dispenser head comprising:
a) at least one first tubular element, which extends around a longitudinal axis and which defines a main containment chamber;
b) at least one second tubular element at least partially housed in the main containment chamber so as to be movable along the longitudinal axis;
wherein the dispenser head is joined to the telescopic moving column in such a way as to be translatable along the longitudinal axis; and
supply means of the fluid to the nozzle comprising at least one fluid supply circuit which extends at least partially inside said tubular elements.

2. Apparatus according to claim 1, wherein the supply means comprise a supply duct which extends at least partially inside the telescopic column.

3. Apparatus according to claim 1, wherein at least a portion of the supply circuit comprises the compartments defined by the first and by the second tubular element.

4. Apparatus according to claim 1, wherein the movement between the tubular elements occurs in such a manner as to guarantee a fluidic seal between them.

5. Apparatus according to claim 1, wherein the nozzle is in fluidic connection with the main containment chamber through valve means suitable for allowing/preventing the emission of the jet from the nozzle.

6. Apparatus according to claim 1, wherein translation between the tubular elements occurs by means of a movement fluid different from that dispensed from the nozzle.

7. Apparatus according to claim 6, further comprising a pneumatic or hydraulic movement circuit, inside which the movement fluid flows to enable translation between the tubular elements.

8. Apparatus according to claim 7, wherein the supply circuit and the movement circuit are reciprocally isolated and are suitable for being independently activated.

9. Apparatus according to claim 7, further comprising a telescopic supply column at least partially housed in the telescopic moving column.

10. Apparatus according to claim 9, wherein between the telescopic supply column and the telescopic moving column a fluid chamber is defined, preferably annular-shaped, inside which the movement fluid flows.

11. Apparatus according to claim 1, comprising stopping means of the telescopic moving column suitable for limiting the stroke of said column along the longitudinal axis, such as a tie-rod.

12. Apparatus according to claim 1, comprising axial blocking means of the telescopic moving column suitable for joining the tubular elements in translation, such as a fastening element acting radially between said elements.

13. Apparatus according to claim 1, further comprising shut-off means in fluidic connection with the nozzle to allow/prevent the emission of said jet of fluid, and/or to regulate the intensity or flow of the latter.

14. Apparatus according to claim 1, wherein the jet of fluid is rotatable around an axis parallel to the longitudinal axis and/or suitable for being inclined in relation to said axis.

15. Apparatus according to claims 1, further comprising means for inclining the telescopic moving column to direct the longitudinal axis in relation to a support surface.

16. Apparatus according to claim 1, further comprising detector means, for example visual, associated with the dispenser head.

17. Fire-fighting vehicle mounting an apparatus for dispensing fluids according to claim 1.
